(19) United States
(12) Patent Application Publication
(10) Pub. No.: US 2026/0133747 A1
(43) Pub. Date: May 14, 2026

(54) MANAGING APPLICATION VARIANTS IN A CONTENT CONNECTIVITY SESSION

(71) Applicant: Lenovo (Beijing) Limited, Beijing (CN)

(72) Inventors: Xuejin Wang, Xiamen (CN); Amit Kumar Agrawal, Bangalore (IN); Zhiyi Cai, Fujian (CN)

(73) Assignee: Lenovo (Beijing) Limited, Beijing (CN)

(21) Appl. No.: 19/374,592

(22) Filed: Oct. 30, 2025

Related U.S. Application Data
(63) Continuation of application No. PCT/CN2024/131509, filed on Nov. 12, 2024.

(51) Int. Cl. G06F 3/14; G06F 8/71

(52) U.S. Cl. CPC G06F 3/1462; G06F 8/71

(57) ABSTRACT

Techniques for managing application variants in a content connectivity session are described. For example, a client device initiates a content connectivity session between the client device and a remote display device. An input is received to initiate display of an application that is configured for use with the client device. For instance, the application is adapted for use with processing, display, and interface settings of the client device. The client device then detects and launches an alternative version of the application that is adapted for use with the remote display device. For instance, the alternative version of the application is adapted for use with processing, display, and interface settings of the remote display device. The client device then causes digital content depicted by the alternative version of the application to be displayed by the remote display device.

### RELATED APPLICATION

This application claims priority benefit of Application Number PCT/CN2024/131509 filed 12 November 2024 entitled “Managing Application Variants in a Content Connectivity Session,” the disclosure of which is incorporated by reference herein in its entirety.

### BACKGROUND

Today’s modern devices provide users with a variety of different opportunities for viewing and engaging with digital content. For instance, a typical smart device (e.g., a smartphone) supports screen sharing to enable content from the smart device to be displayed on an additional device, such as a remote display device. Such techniques enhance a user experience, and thus are beneficial for a variety of uses such as personal entertainment, business presentations, educational environments, collaborative workspaces, etc. However, conventional screen sharing approaches encounter difficulty when displaying content that is configured for a particular type of device. For instance, digital content configured for a screen of a mobile device often appears distorted, misaligned, or improperly scaled when displayed on a larger display such as a TV or external monitor. Accordingly, screen sharing between devices with differing settings such as screen resolutions, aspect ratios, and/or user interface configurations can result in a poor user experience and offset the benefits associated with screen sharing capabilities.

### BRIEF DESCRIPTION OF THE DRAWINGS

Aspects of managing application variants in a content connectivity session are described with reference to the following Figures. The same numbers may

be used throughout to reference similar features and components that are shown in the Figures:

FIG. 1 depicts an example environment in which aspects of managing application variants in a content connectivity session can be implemented in accordance with one or more implementations.

FIG. 2 depicts an example system for managing application variants in a content connectivity session in accordance with one or more implementations.

FIGS. 3a and 3b depict example implementations for managing application variants in a content connectivity session in which versions of a social media application are managed in accordance with one or more implementations.

FIGS. 4a, 4b, 4c, and 4d depict example implementations for managing application variants in a content connectivity session in which video streaming application variants are managed in accordance with one or more implementations.

FIGS. 5a and 5b depict example implementations for managing application variants in a content connectivity session in which various icon surfacing options are shown in accordance with one or more implementations.

FIG. 6 depicts an example implementation for managing application variants in a content connectivity session in which behavior data is stored in one or more user profiles in accordance with one or more implementations.

FIG. 7 illustrates a flow chart depicting an example method for managing application variants in a content connectivity session in accordance with one or more implementations.

FIG. 8 illustrates a flow chart depicting an example method for managing application variants in a content connectivity session in accordance with one or more implementations.

FIG. 9 illustrates a flow chart depicting an example method for managing application variants in a content connectivity session in accordance with one or more implementations.

FIG. 10 illustrates various components of an example device in which aspects of managing application variants in a content connectivity session can be implemented in accordance with one or more implementations.

### DETAILED DESCRIPTION

Techniques for managing application variants in a content connectivity session are described. The described implementations, for instance, support dynamic execution of different versions of applications during a content connectivity session between a client device, e.g., a mobile device, and a remote display device, e.g., a television monitor. For instance, the described implementations enable real-time transition from an application configured for execution by the client device to an alternative version of the application that is configured for use by the display device, such as to enhance performance of the remote display device during the content connectivity session. In this way, the techniques described herein support efficient use of computational resources and enhanced performance of applications that display a variety of application content before, during, and after a content connectivity session.

According to various implementations, a client device, e.g., a mobile device establishes a content connectivity session between the client device and a remote display device. For instance, the client device establishes connectivity (e.g., wireless and/or wired connectivity) with the remote display device and communicates digital content to the remote display device for output. Accordingly, as part of the content connectivity session, content that is generated, displayed, and/or executed on the client device can be displayed on the remote display device, in whole or in part. For example, the client device is operable to cause the remote display device to display an application interface of an application that is executed by the client device as part of the content connectivity session. The client device can further be leveraged to control functionality of the application, e.g., via input received via a touchscreen of the client device.

Consider an example in which a user desires to “screen cast” digital video content from the client device, e.g., a mobile device, to a larger screen of a remote display device. Accordingly, the client device receives an input to launch an application, e.g., a video streaming application that depicts digital content such as movies and TV shows. In this example, the video streaming application is a mobile application that is configured with display, processing, and interface settings particular to the client device. For instance, the mobile application is configured to display digital videos with an aspect ratio, resolution, and refresh rate particular to a mobile device. The mobile application also includes interface elements, e.g., selectable indicia, that are positioned and sized to be used by a device with a mobile form factor.

However, because the mobile application is adapted for use by the client device, application content of the mobile application can appear distorted, misaligned, or improperly scaled when displayed by the display device as part of the content connectivity session. Further, processing disparities between the client device and the display device can cause performance issues during output of the application content of the mobile application by the display device, such as lag, reduction in rendering capability, and/or inefficient resource allocation. Because the mobile application is configured for a device having a mobile form factor, the mobile application also causes discrepancies in interface elements when displayed by the display device, such as incorrect font/icon size, inconveniently located interface elements, navigational challenges, and/or orientation conflicts.

Some conventional approaches attempt to resize and/or rescale application content during a screen sharing scenario. However, such “brute-force” techniques are imprecise and often do not correct visual disparities caused by mismatched device properties between the client device and the remote display device. These conventional techniques are also computationally expensive, which can cause issues such as lag and poor rendering quality, and further do not address interface and/or processing disparities between differing computing devices.

To overcome these limitations, the techniques described herein support dynamic transitioning between execution of an application configured for the client device to an application variant configured for the remote display device. Continuing with the above example, responsive to receipt of the input to launch the mobile application, the client device determines whether the client device includes an alternative version of the video streaming application, e.g., an application variant that is configured for use with the remote display device.

The application variant, for instance, is operable to perform substantially similar functionality as the mobile application such as to display video content such as movies and TV shows. However, the application variant is adapted for use with display, processing, and interface settings to optimize performance of the remote display device. For instance, the application variant is configured to display digital videos with an aspect ratio, resolution, and refresh rate particular to the remote display device. The application variant also includes interface elements that are positioned and sized based on a relatively larger screen of the remote display device.

In an example in which the client device does not include a suitable application variant, the client device can query an application repository, e.g., an application store, to obtain the application variant. For instance, the client device compares metadata from one or more candidate applications stored in the application repository with the mobile application and/or settings of the remote display device to identify a suitable application variant. Once identified, the client device downloads the application variant from the application repository.

The client device then launches the application variant. As part of the content connectivity session, the client device further causes application content from the application variant to be displayed by the remote display device. Continuing the above example, the client device causes digital video content associated with the video streaming application (e.g., the application variant) to be displayed by the remote display device. Because the application variant is optimized for use by the remote display device, application content from the application variant has an enhanced visual quality relative to application content from the mobile application when displayed by the remote display device.

For example, the application variant has display settings such as an aspect ratio, resolution, and refresh rate that are configured to improve display by the remote display device. An application interface of the application variant is further optimized for a relatively large screen size of the remote display device, such as including additional interface elements relative to the mobile application. For instance, the mobile application includes a reduced number of control icons (e.g., icons to pause, fast forward, and rewind a digital video) while the application variant leverages a larger screen size to include an expanded set of control icons, e.g., volume control, playback speed controls, subtitles options, video quality settings, etc.

Further, the application variant is configured with processing settings to enhance computational efficiency when displayed by the remote display device. For instance, the application variant includes graphics quality settings, scaling settings, and resource management settings particular to the remote display device. Accordingly, by displaying application content via an application explicitly configured for use by the remote display device, the techniques described herein can conserve computational resources that may otherwise be used to iteratively resize and/or rescale the application content throughout a content connectivity session. In this way, the described techniques can improve the operation of computing devices and reduce a user burden by performing such application variant management processes automatically.

While features and concepts of managing application variants in a content connectivity session can be implemented in any number of environments and/or configurations, aspects of managing application variants in a content connectivity session are described in the context of the following example systems, devices, and methods.

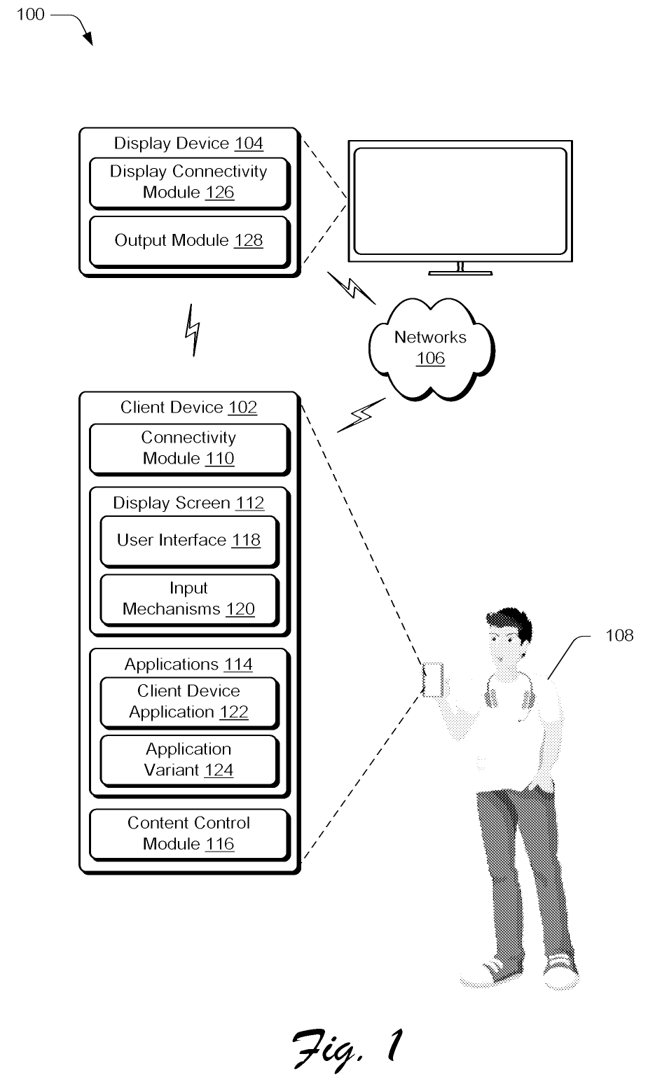

FIG. 1 illustrates an example environment 100 in which aspects of managing application variants in a content connectivity session can be implemented. The environment 100 includes a client device 102 and a display device 104 which are interconnectable by a network 106 to enable content from the client device 102 to be displayed by the display device 104, for instance as part of a content connectivity session. In this particular example, the client device 102 represents a portable device that can be carried by a user 108, such as a mobile device, a smartphone, a tablet device, a docked mobile device connected to a monitor, a wearable computing device, (e.g., a smartwatch or a fitness tracker), augmented reality (“AR) and/or virtual reality (“VR”) devices (e.g., AR/VR glasses, projectors, headsets, etc.), and so forth.

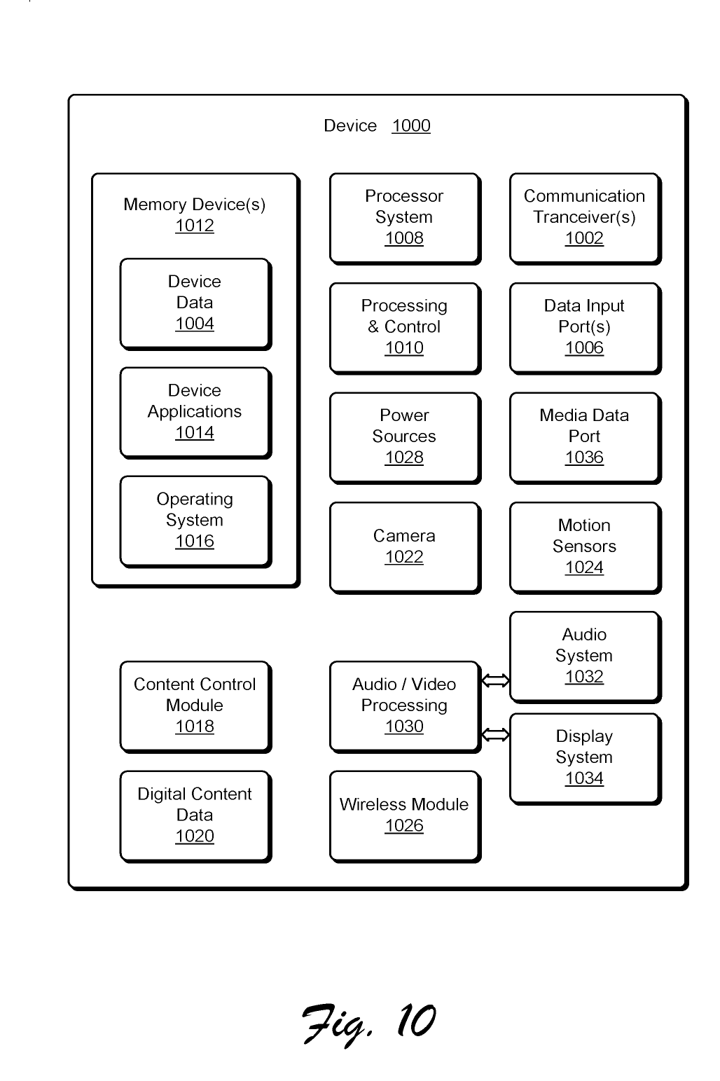

Further, the display device 104 represents a remote display device such as a laptop computer, external monitor, smart television screen, a desktop computer, augmented reality (“AR) and/or virtual reality (“VR”) devices (e.g., AR/VR glasses, projectors, headsets, etc.), and so forth. These examples are not to be construed as limiting, however, and the client device 102 and/or the display device 104 can be implemented in a variety of different ways and form factors. Example attributes of the client device 102 and the display device 104 are discussed below with reference to the device 1000 of FIG. 10.

The client device 102 includes various functionality that enables the client device 102 to perform different aspects of managing application variants in a content connectivity session as discussed herein, including a connectivity module 110, a display screen 112, one or more applications 114, and a content control module 116. The connectivity module 110 represents functionality (e.g., logic and hardware) for enabling the client device 102 to interconnect with other devices and/or networks, such as the display device 104 and the network 106. The connectivity module 110, for instance, enables wireless and/or wired connectivity of the client device 102 to the display device 104, such as part of a content connectivity session as further described in more detail below.

The display screen 112 represents functionality (e.g., hardware and logic) for enabling visual output via the client device 102, for instance, via a user interface 118. The user interface 118, for instance, includes one or more visual, auditory, and/or tactile elements that enable the user 108 to interact with digital content displayed by the client device 102. The display screen 112 and the user interface 118 are configurable with a variety of settings particular to the client device 102, such as display settings (e.g., resolution, aspect ratio, refresh rate, contrast, color profile, scaling, orientation), processing settings (e.g., upscaling/downscaling, image processing modes, computational resources usage and delegation, refresh rate, power-saving modes, overdrive settings to increase pixel response times, etc.), and/or interface settings, e.g., menu layouts, navigation, language settings, on-screen display settings, input sensitivity and responsiveness, theme, selectable indicia positioning and/or sizing, accessibility settings, input method customizations, etc.

In various examples, the display screen 112 further includes one or more input mechanisms 120. The input mechanisms 120 represent functionality for enabling input to the client device 102, such as user input to invoke functionality of the client device 102. The input mechanisms 120 can include functionality for receiving proximity-based input to the client device 102, such as stylus input, user touch input, contactless input based on proximity of a user’s finger and/or a stylus to the client device 102, and so forth. In various examples, the input mechanisms 120 include one or more touch sensors and/or touch screens. This is by way of example and not limitation, and the input mechanisms 120 can include and/or support one or more of a virtual keyboard, voice input components, environmental sensors, motion gestures, biometric sensors, etc.

The one or more applications 114 represent functionality for performing different computing tasks via the client device 102, such as gaming (e.g., mobile and/or touch-based gaming), media consumption (e.g., content streaming), productivity tasks (e.g., word processing, content generation, data analysis, etc.), web browsing, communication with other devices, and so forth. The applications 114, for instance, include a client device application 122 as well as an application variant 124. The client device application 122 is configured (e.g., optimized) for execution by the client device 102. For instance, the client device application 122 is adapted for use with display, interface, and/or processing settings of the client device 102, such as to accommodate various settings of the display screen 112 and/or the user interface 118.

The application variant 124 is representative of an alternative version of the client device application 122. For instance, the application variant 124 shares core workflow, features, data processing, and/or software architecture with the client device application 122 to perform a same or similar overall functionality as the client device application 122. The application variant 124, however is configured (e.g., optimized) for execution by a device different than the client device 102. For instance, the application variant 124 is adapted for use with display, interface, and/or processing settings of the display device 104.

The content control module 116 represents functionality for performing various aspects of managing application variants in a content connectivity session as described herein. Generally, the content control module 116 is operable to initiate, establish, and/or support a content connectivity session with the display device 104, such as to generate and/or communicate digital content to be displayed by the display device 104. For instance, the content control module 116 causes digital content from instances of the applications 114 to be displayed by the display device 104.

As further described in more detail below, the content control module 116 can manage execution, termination, surfacing, display, and so forth of the client device application 122 and/or the application variant 124 based on a variety of considerations. For instance, the content control module 116 can launch the application variant 124 and terminate execution of the client device application 122 responsive to initiation of a content connectivity session between the client device 102 and the display device 104.

The display device 104 represents functionality for various types of content output, such as output of visual and audible content. The display device 104 can be implemented in various ways, such as one or more of a television (e.g., a smart TV), a display panel, a projector display, a VR/AR compatible device, a computing device with an associated display device, an external monitor, an additional mobile device, and so forth. In at least one implementation the display device 104 represents a dedicated remote display device configured to output visual content generated by other devices, such as content generated at the client device 102 and transmitted to the display device 104 for display. Alternatively or additionally, the display device 104 includes various computing functionality.

The display device 104 includes various functionality for enabling the display device 104 to output content such as content received from the client device 102, including a display connectivity module 126 and an output module 128. The display connectivity module 126 represents functionality (e.g., logic and hardware) for enabling the display device 104 to interconnect with other devices and/or networks, such as the client device 102 and the network 106, such as to enable collaborative data communication between the display device 104 and the client device 102. The display connectivity module 126, for instance, enables wireless and/or wired connectivity of the display device 104 such as for receiving content from other devices for display as part of a content connectivity session.

In at least one implementation the display connectivity module 126 connects to the network 106 (e.g., via wireless and/or wired connectivity) for intercommunication with other devices and/or networks. Alternatively or additionally the display connectivity module 126 enables direct device-to-device connectivity with other devices, such as the client device 102. The connectivity module 110 of the client device 102 and the display connectivity module 126 of the display device 104, for instance, are configured to communicate via a variety of different wireless protocols, such as Wireless Local Area Network (WLAN) (e.g., Wi-Fi), Wi-Fi Direct, wireless short distance communication (e.g., Bluetooth^{TM} (including BLE), Near Field Communication (NFC)), and so forth.

The output module 128 represents functionality for enabling content output by the display device 104, such as visual content and/or audible content. The output module 128, for instance, includes a display driver and/or other logic and hardware to output content by the display device 104. The output module 128 can manage a variety of settings particular to the display device 104, such as display settings (e.g., resolution, aspect ratio, refresh rate, contrast, color profile, scaling, orientation), processing settings (e.g., upscaling/downscaling, image processing modes, computational resources usage and delegation, refresh rate, power-saving modes, overdrive settings to increase pixel response times, input processing settings, etc.), and/or interface settings, e.g., menu layouts, navigation, language settings, on-screen display settings, input sensitivity and responsiveness, theme, selectable indicia positioning, accessibility settings, input method customizations, etc. In various examples, the application variant 124 is adapted for use with such settings particular to the display device 104.

Having discussed an example environment in which the disclosed techniques can be performed, consider now some example scenarios and implementation details for implementing the disclosed techniques.

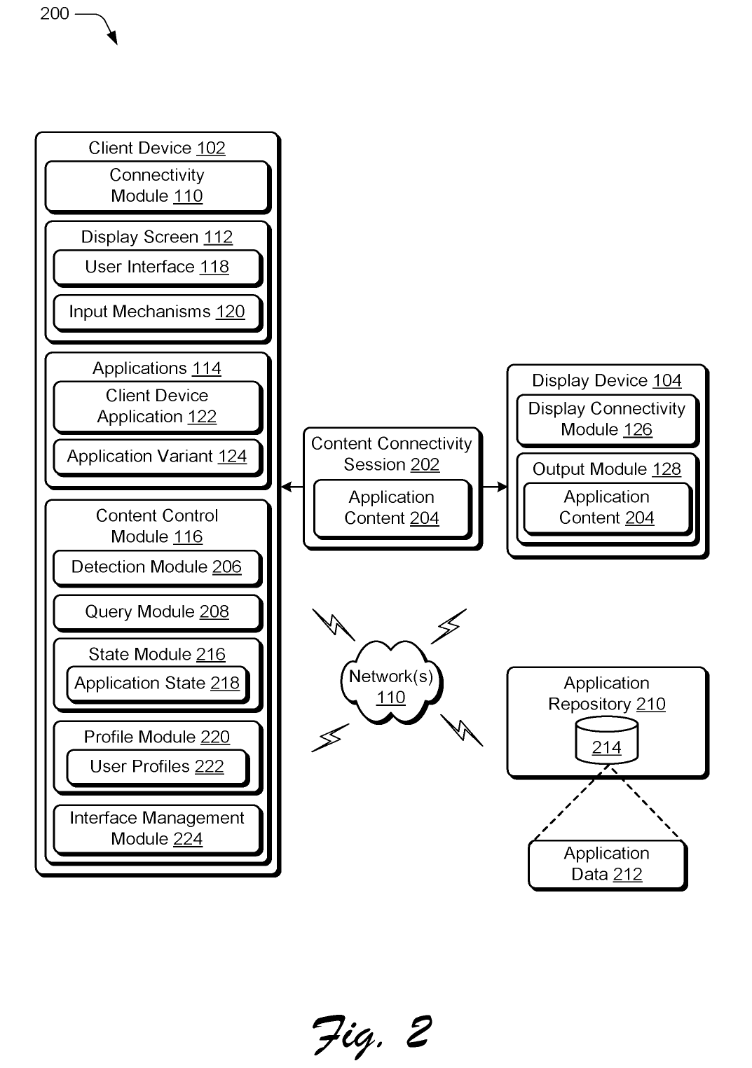

FIG. 2 depicts an example system 200 for managing application variants in a content connectivity session in accordance with one or more implementations. The system 200 can be implemented in the environment 100 and incorporates attributes of the environment 100 introduced above.

In the example system 200, a content connectivity session 202 is established between the client device 102 and the display device 104. The content connectivity session 202, for instance, enables the client device 102 to transmit content to the display device 104 for output via wireless and/or wired connectivity. In at least one implementation, the content connectivity session 202 is established via negotiation between the connectivity module 110 of the client device 102 and the display connectivity module 126 of the display device 104. For instance, the content control module 116 can cause the connectivity module 110 to communicate with the display connectivity module 126 to establish the content connectivity session 202.

In various examples, the content connectivity session 202 is initiated by a user 108, for instance responsive to a user input to the input mechanisms 120. For instance, the user 108 can initiate the content connectivity session 202 by selection of one or more icons displayed in the user interface 118. In at least one example, the content connectivity session 202 is initiated responsive to a particular user gesture applied to the display screen 112, such as a user input to “swipe” to initiate the content connectivity session 202.

In various examples, the content connectivity session 202 is established automatically and without user intervention, such as responsive to one or more of the applications 114 being launched by the client device 102 and/or detection of the display device 104 in proximity to the client device 102. In an example, the client device 102 launches a client device application 122. In this example, the client device application 122 is a media application and initiation of the content connectivity session 202 is responsive to a detection that the application 114 is a media application and supports playback of digital content. This is by way of example and not limitation and the techniques described herein are extensible to a variety of types of applications 114.

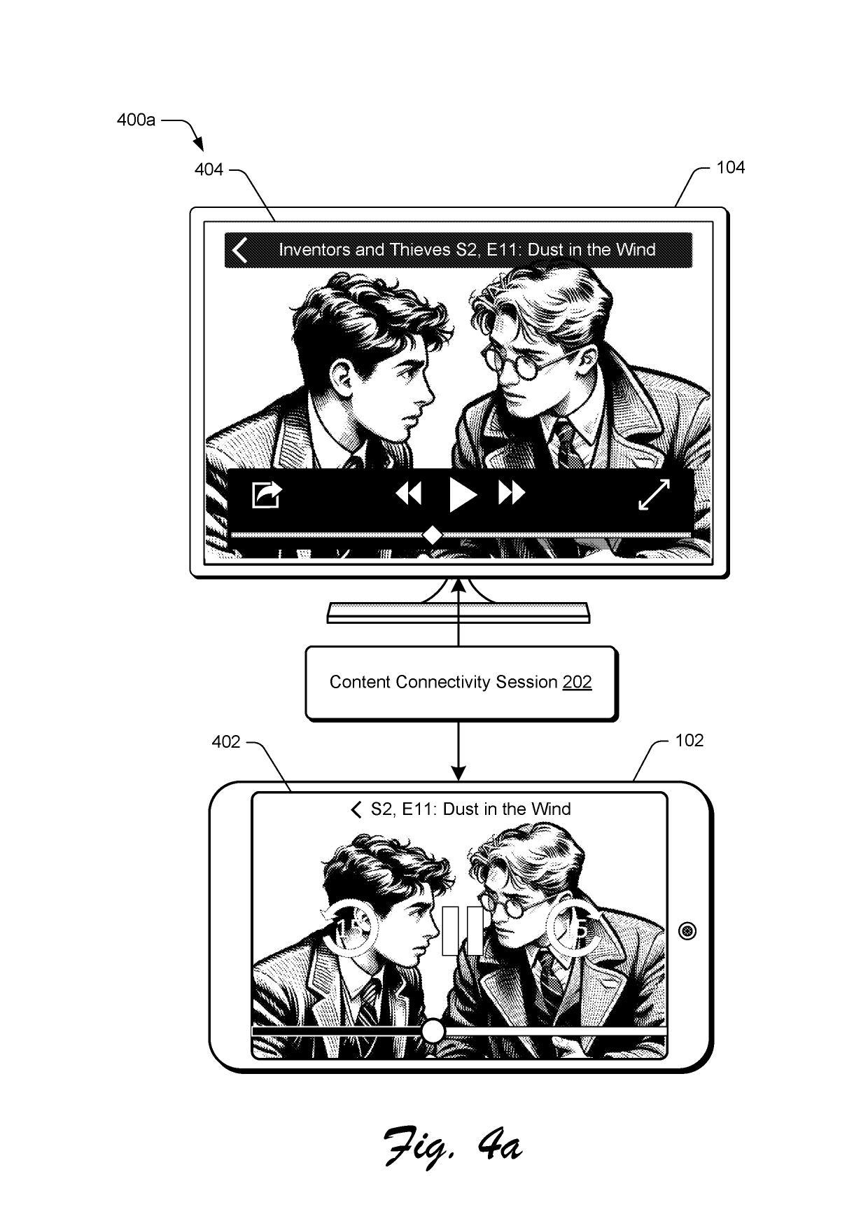

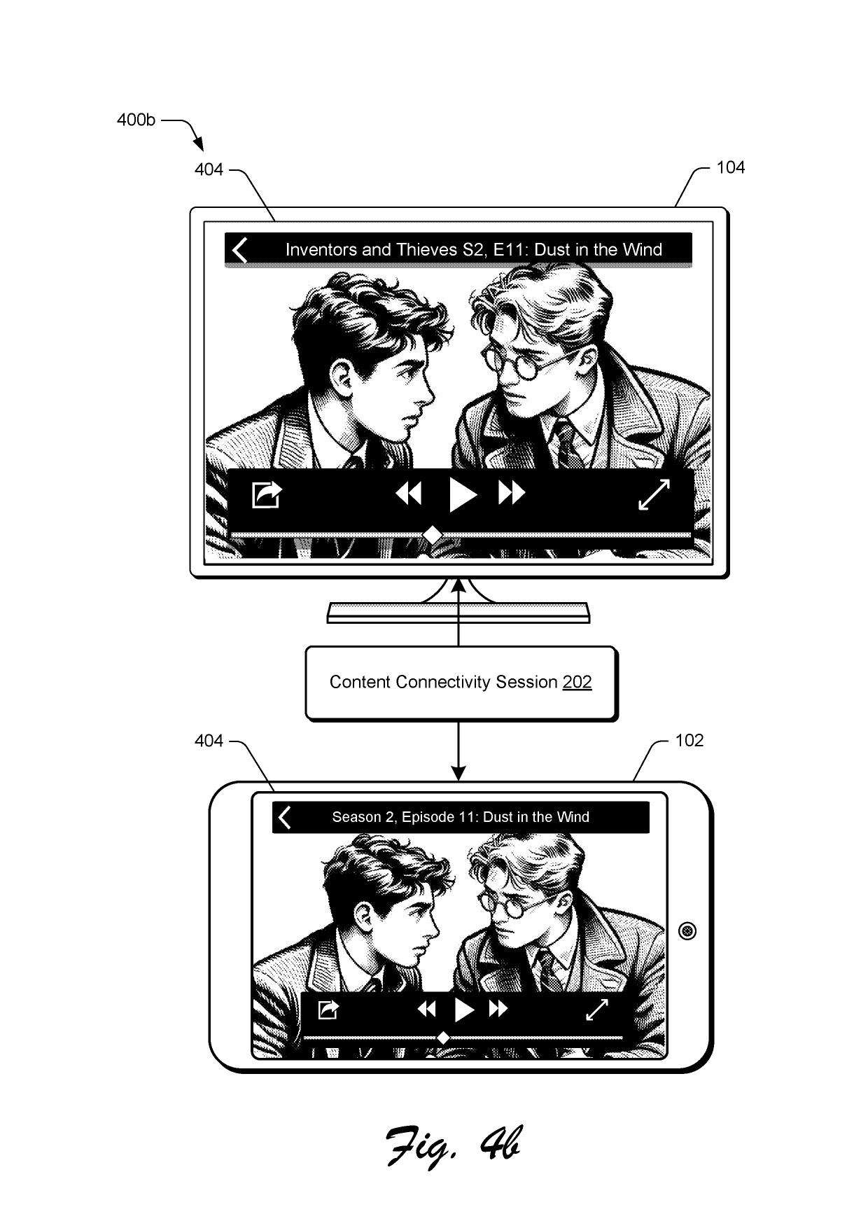

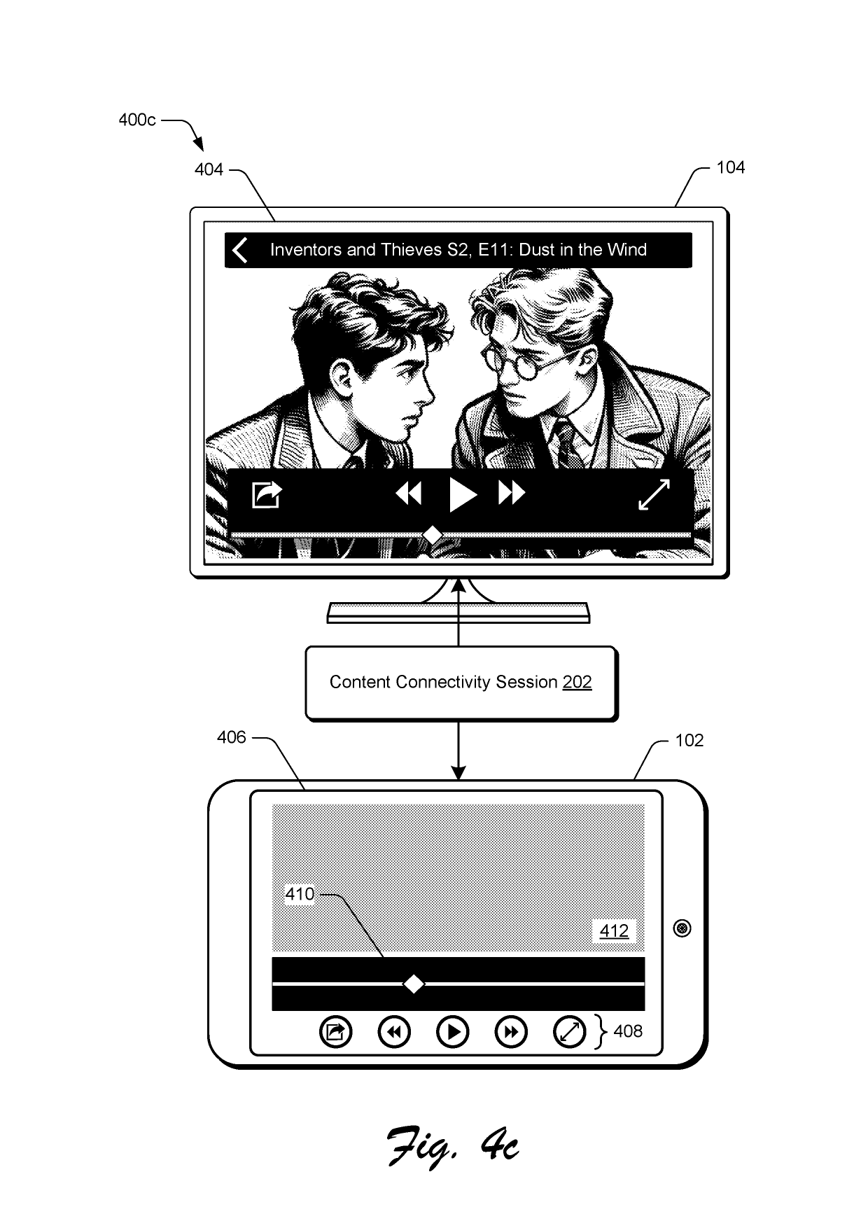

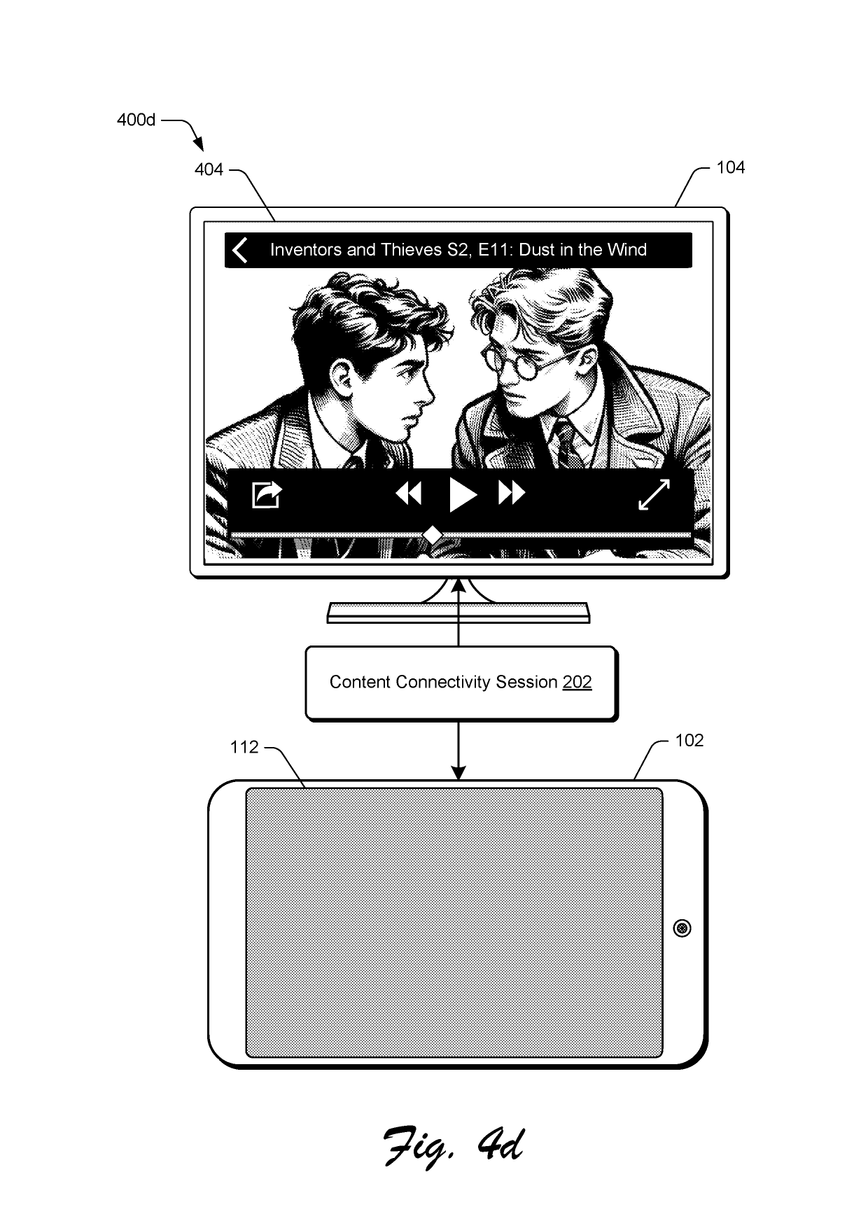

As part of the content connectivity session 202, the client device 102 can control one or more operations of the display device 104. For instance, the client device 102 can receive one or more inputs, such as to the input mechanisms 120, which control operations of the display device 104. In this way, the client device 102 can be implemented as a controller for digital content displayed by the display device 104 such as described in more detail below with respect to FIG. 4c.

The content control module 116 receives an input to initiate display of an application 114, e.g., a client device application 122. For instance, the input includes a user input to one or more of the input mechanisms 120 to launch the client device application 122. By way of example, a user 108 navigates the user interface 118 and selects an icon associated with the client device application 122 to cause the client device 102 to execute application code associated with the client device application 122 to render an application interface for display by the display screen 112.

The client device application 122 is configured (e.g., optimized) for execution by the client device 102. For instance, the client device application 122 is adapted for use with display, interface, and/or processing settings of the client device 102, such as to accommodate various settings and/or parameters of the display screen 112 and/or the user interface 118 of the client device 102. For example, the client device application 122 includes application configuration parameters that are set to operate within predefined thresholds that maximize a performance, stability, and/or user experience of the client device application 122 when executed by the client device 102.

Consider an example in which the client device 102 is a mobile device, e.g., a smartphone. The client device application 122 is a mobile application designed for execution by the mobile device. Accordingly, the client device application 122 is configured to perform tasks/services particular to hardware and/or software capabilities of the client device 102, such as based on processing power, memory, display characteristics, and input methods such as touchscreen interfaces, sensors, or wireless communication protocols.

In this example, the client device application 122 is optimized for display on the display screen 112 (e.g., a relatively smaller screen than the display device 104) and accordingly is configured based on a resolution, aspect ratio, refresh rate, etc. of the display screen 112. The client device application 122 is further configured to support input via a touch-based user interface 118 and input mechanisms 120 such as taps, swipes, and gestures. Further, a layout of visual elements of the client device application 122 (e.g., selectable indicia, buttons, menus, digital content, etc.) is condensed to accommodate a relatively small form factor and a relatively high pixel density of the display screen 112.

As part of the content connectivity session 202, the client device 102 can display digital content from the applications 114 via the display screen 112 as well as generate digital content, e.g., application content 204, to be communicated to the output module 128 for display by the display device 104. For instance, the client device 102 launches the client device application 122 and communicates application content 204 associated with the client device application 122 to the display device 104 for display. By way of example, the client device application 122 is a media streaming application, and the application content 204 includes digital video content, such as videographic, photographic, and/or audial digital content.

However, because the client device application 122 is configured for use by the client device 102, application content 204 from the client device application 122 can appear distorted, misaligned, or improperly scaled when displayed by the display device 104. Further, processing disparities between the client device 102 and the display device 104 can cause performance issues during output of the application content 204 by the display device 104, such as lag, reduction in rendering capability, and/or inefficient resource allocation. The client device application 122 is further configured for the user interface 118 of the client device 102, e.g., for a mobile form factor, and thus experiences discrepancies in font/icon size, navigation challenges, and/or orientation conflicts when displayed by the display device 104.

Some conventional approaches attempt to address these issues by resizing and/or rescaling mobile digital content for use with a larger display. However, such techniques often do not correct the visual disparities caused by mismatched display properties between different device form factors and specifications. Further, these techniques do not address interface and/or processing disparities between the different devices.

Accordingly, the content control module 116 can cause the client device 102 to launch an application variant 124. The application variant 124, for instance, is representative of an alternative version of the client device application 122. For instance, the application variant 124 shares core workflow, features, data processing, and/or software architecture with the client device application 122 to perform a same or similar overall functionality as the client device application 122. The application variant 124, however, is configured (e.g., optimized) for execution by a device different than the client device 102. For instance, the application variant 124 is adapted for use with display, interface, and/or processing settings of the display device 104. For example, the application variant 124 includes application configuration parameters that are set to operate within predefined thresholds that maximize a performance, stability, and/or user experience of the application variant 124 when executed by the display device 104.

Consider an example in which the client device application 122 is a media streaming application associated with a particular content streaming service. As described above, the client device application 122 is adapted for use by the client device 102. Accordingly, the application variant 124 is also a media streaming application associated with the particular content streaming service however is adapted for use with the display device 104.

In this example, the client device application 122 and the application variant 124 include substantially similar operational logic that supports interaction with a common set of tools, data, or services, such as to stream media content from the particular content streaming service. However, the client device application 122 and the application variant 124 have differing visual settings and processing settings to support optimal performance of the respective applications. Further, a layout and arrangement of icons and/or various selectable indicia vary between an application interface of the client device application 122 and an application interface of the application variant 124.

Accordingly, the content control module 116 includes a detection module 206 that is operable to detect that the client device application 122 is configured with application settings particular to the client device 102. For instance, the detection module 206 can obtain metadata associated with the client device application 122 that indicates that the client device application 122 is configured for a particular type of device, e.g., a mobile device. Additionally or alternatively, the detection module 206 determines a screen size and/or layout of the application interface supported by the client device application 122. Based on the layout and/or screen size, the detection module 206 determines that the client device application 122 is configured for the client device 102. The detection module 206 may further detect one or more permissions and/or hardware access, operating system compatibility, input and/or outputs, file structure, and such that indicates the client device application 122 is adapted for use by the client device 102.

In various examples, the detection module 206 further determines that the client device application 122 is not configured for use by the display device 104. For instance, the client device application 122 may be functional on the display device 104, however is not optimized for settings and/or characteristics of the display device 104. Accordingly, the detection module 206 can determine that display of the client device application 122 by the display device 104 would result in one or more visual, interface, and/or processing deficiencies that may degrade a user experience with the content connectivity session 202.

The content control module 116 further includes a query module 208 that is operable to determine whether the client device 102 includes an alternative version of the client device application 122 configured for the display device 104. For instance, the query module 208 identifies one or more variants of the client device application 122 that are stored (e.g., locally and/or remotely) by the client device 102. In at least one example, the query module 208 accesses metadata associated with the client device application 122 to identify potential variants of the client device application 122. The query module 208 is then able to determine whether one or more of the potential variants are adapted for use with the display device 104, such as by comparing metadata associated with the potential variants with specifications of the display device 104.

In an example in which the client device 102 does not include the application variant 124, the query module 208 is operable to query an application repository 210 to determine if the application repository 210 includes one or more application variants 124. For instance, the application repository 210 maintains application data 212 that pertains to a variety of applications 114 in storage 214. In one or more examples, the application repository 210 is representative of an application “store” such as a digital platform to browse, download, update, and/or install a variety of applications 114.

For example, the query module 208 accesses the application repository 210 to search for an application variant 124. The query module 208, for instance, compares metadata from one or more candidate applications with the client device application 122 and/or settings of the display device 104 to identify an application variant 124 of the client device application 122 that is configured (e.g., optimized) for use by the display device 104. Upon determination that the application repository 210 includes the application variant 124, the query module 208 causes the client device 102 to download the application variant 124 from the application repository 210.

Once the client device 102 includes the application variant 124, the content control module 116 causes the client device 102 to launch the application variant 124. The application variant 124, for instance, is configured with one or more display, processing, and/or interface settings of the display device 104. As part of the content connectivity session 202, the content control module 116 causes application content 204 associated with the application variant 124 to be displayed by the display device 104.

The content control module 116 further includes a state module 216 that is operable to manage an operation state, e.g., an application state 218, of one or more of the applications 114, e.g., the client device application 122 and/or the application variant 124. The application state 218, for instance, includes a current condition and/or status of an application 114 at a particular moment in time. The application state 218 may include one or more data elements, variables, and/or an operational context of an application 114 at a particular moment such as behavior, processing activities, and/or user interactions related to the application 114.

For example, the application state 218 includes data elements stored by an application 114 at a particular time. In an example in which the client device application 122 is a shopping application, the application state 218 includes a user shopping history and items stored in a digital cart associated with the shopping application. In an additional or alternative example, the application state 218 includes a user interface state that describes interactive elements displayed by an application 114. For instance, the client device application 122 is a document interaction application the user 108 is using to complete a form, and the application state 218 indicates field of the form that have been completed and fields that have not been completed.

The application state 218 may describe an operational state of an application 114, such as what the application 114 “is doing”. For instance, the application state 218 describes whether the client device application 122 is idle, active, paused, waiting for a user input, etc. Additionally or alternatively, the application state 218 describes a session state of an application 114 that reflects a status of temporary data particular to a user session with the application 114, such as to indicate where a user “left off”. By way of example, the client device application 122 is a media streaming application and the application state 218 indicates a particular timestamp of a particular video displayed by the media streaming application.

The state module 216 can determine an application state 218 of the client device application 122 and configure the application variant 124 to match the application state 218 of the client device application 122. For instance, the content control module 116 causes the client device 102 to launch the application variant 124 as part of the content connectivity session 202 and configure the application variant 124 to emulate the application state 218 of the application variant 124. In this way, the techniques described herein provide a seamless transition between application content 204 displayed by the client device application 122, e.g., via the client device 102, and application content 204 displayed by the application variant 124, e.g., displayed via the display device 104.

By way of example, the client device application 122 is a video streaming application that displays a digital video at a particular time stamp. The client device 102 initiates a content connectivity session 202 with the display device 104 and launches the application variant 124. The state module 216 configures the application variant 124 to resume playback of the digital video at the particular timestamp.

The content control module 116 further includes a profile module 220. The profile module 220, for instance, maintains one or more user profiles 222. The user profiles 222 can store a variety of information that describes user interactions with the applications 114. For example, a user profile 222 includes user information, user preferences, account information, and/or usage data associated with a user 108. In one or more examples, the user profiles 222 include a user categorization based on a frequency of use of different types of applications 114. For instance, the user profiles 222 can include a gamer profile for a user 108 that engages with gaming applications relatively frequently, a productivity profile for a user 108 that engages with gaming applications above a threshold level of frequency, etc.

The profile module 220 can perform a variety of functionality based on the user profiles 222. For instance, a user profile 222 indicates that the user 108 frequently initiates a content connectivity session 202 with a display device 104 for gaming applications. Accordingly, the profile module 220 can automatically search the application repository 210 for an application variant 124 when the user 108 downloads a new gaming application. The profile module 220 is then operable to download the application variant 124 and/or to generate a recommendation to download the application variant 124.

In at least one example, the profile module 220 is operable to detect a particular user profile 222 associated with the client device application 122. The profile module 220 can further associate the particular user profile 222 with the application variant 124. In this way, the profile module 220 supports transferring personalized functionality (e.g., user account information and/or customized settings) of the particular user profile from the client device application 122 to the application variant 124.

The content control module 116 further includes an interface management module 224. The interface management module 224 can control content displayed by the client device 102, such as during a content connectivity session 202. For instance, the interface management module 224 can terminate execution of the client device application 122 responsive to launch of the content connectivity session 202 and/or responsive to launch of the application variant 124. For example, the interface management module 224 terminates execution of the client device application 122 by the client device 102 responsive to launch of the application variant 124 to conserve computational resources.

The interface management module 224 can further cause the client device 102 to display either, both, or neither the client device application 122 and/or the application variant 124. In an example, the interface management module 224 causes the client device 102 to continue to display the client device application 122 during the content connectivity session 202. Additionally or alternatively, the interface management module 224 causes the client device 102 to display the application variant 124.

In at least one example, the interface management module 224 causes the client device 102 to display a controller interface, such as to control digital content displayed by the display device 104 and part of the content connectivity session 202 as further described below with respect to FIG. 4c. In an additional or alternative example, the interface management module 224 causes the client device 102 to display neither the client device application 122 nor the application variant 124 during the content connectivity session 202. For instance, the interface management module 224 causes the client device 102 to maintain execution of the client device application 122 and/or the 124 in a background process while displaying alternative digital content. In this way, the client device 102 can be used for additional functionality while engaged in a content connectivity session 202.

The interface management module 224 can further control interface elements displayed by the client device 102 before, during, and after the content connectivity session 202. In one example, the interface management module 224 hides an icon associated with the application variant 124 from the user interface 118 of the client device 102 when the client device 102 is not engaged in the content connectivity session 202. Additionally or alternatively, when the client device 102 is engaged in the content connectivity session 202, the interface management module 224 can hide an icon associated with the client device application 122 from the user interface 118 such as for a duration of the content connectivity session 202.

Accordingly, the techniques described herein support dynamic provision of an optimized and context-appropriate experience for various configurations of processing devices while maintaining consistent core functionality of applications across the various configurations.

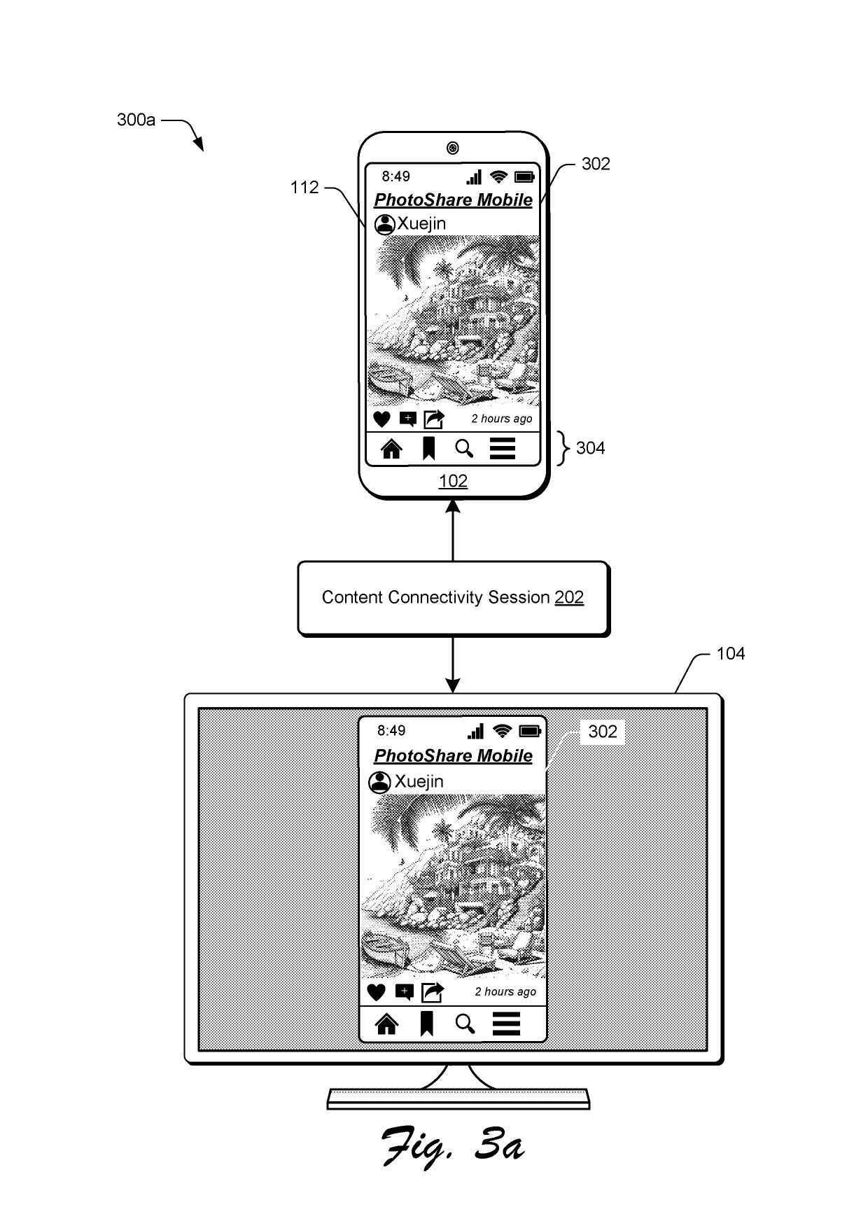

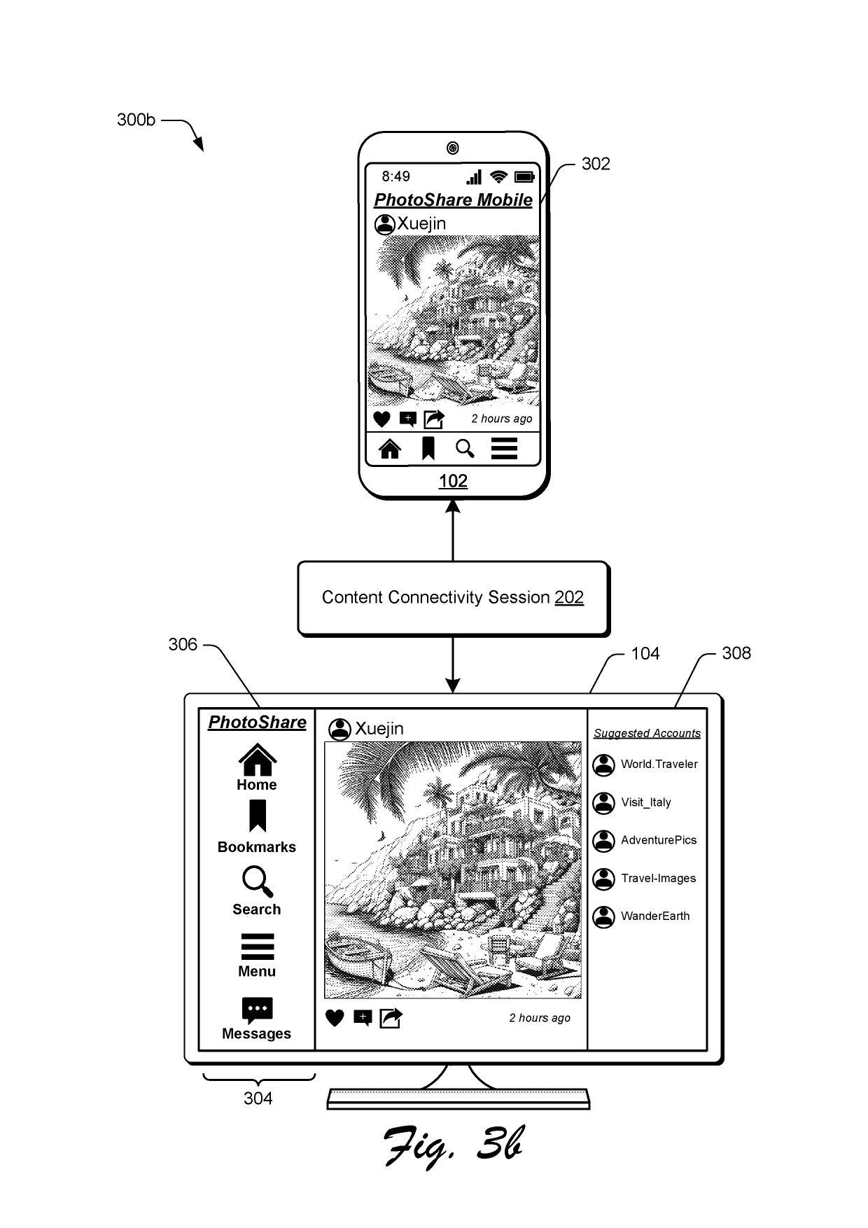

FIGS. 3a and 3b depict example implementations 300a, 300b for managing application variants in a content connectivity session in which versions of a social media application are managed in accordance with one or more implementations. As shown in FIG. 3a, a client device 102 establishes a content connectivity session 202 with a display device 104. The client device 102, for instance, executes a client device application 122 which in this example is a social media photo sharing application, e.g., “PhotoShare”.

The client device 102 displays a mobile application interface 302 associated with the client device application 122. The mobile application interface 302 has a variety of selectable indicia to interact with and view digital content as part of a social media photo sharing experience. The client device application 122 further has processing settings, interface settings, and display settings that are configured (e.g., optimized) for the client device 102, which in this example has a mobile device form factor. As depicted in the illustrated example, the mobile application interface 302 has a display setting such as a resolution and aspect ratio to fit the display screen 112.

The mobile application interface 302 further includes strategically configured icons and selectable indicia positioned to facilitate an intuitive user experience in a mobile setting. For instance, selectable indicia 304 are positioned towards a bottom of the mobile application interface 302 in a “thumb zone” such that the selectable indicia 304 are within easy reach of a thumb of a user 108. The client device application 122 further includes processing settings particular to a mobile device that facilitate efficient computational resource usage of the client device 102. For instance, the processing settings include memory allocation settings, data caching and storage settings, network usage settings, and background data processing restrictions.

In this example, the client device 102 communicates application content 204 associated with the client device application 122 to be displayed by a display device 104 as part of the content connectivity session 202. The display device 104 in this example is representative of a remote display device such as a television screen. For instance, a user 108 wishes to display the social media photo sharing application on a relatively larger display of the display device 104. Accordingly, the display device 104 displays the mobile application interface 302 as part of the content connectivity session 202.

However, because the client device application 122 is configured for use with the client device 102, the client device application 122 exhibits a variety of limitations when displayed by the display device 104. For instance, the mobile application interface 302 appears improperly scaled and distorted when displayed by the display device 104. As illustrated, the display device 104 exhibits a “pillar-boxing” visual artifact such that a left and right portion of the screen include empty blank space. This artifact is attributable to a difference in aspect ratio between the client device 102 and the display device 104.

Further, processing disparities between the client device 102 and the display device 104 result in performance issues during output of the mobile application interface 302 by the display device 104, such as lag and reduction in image resolution. Additionally, interface settings of the client device application 122 are configured for a mobile environment, e.g., positioning of the several selectable indicia 304 in a thumb-zone, and thus are not intuitive for use with the display device 104. Some conventional approaches may attempt to resize the mobile application interface 302, such as to better fit the display device 104, however such techniques are inaccurate and do not consider processing and/or interface settings of the display device 104.

To overcome these limitations, the client device 102 is operable to manage application variants throughout a content connectivity session 202. As depicted in FIG. 3b, for instance, the client device 102 implements the techniques described herein to identify and launch an application variant 124 of the client device application 122. The application variant 124, for instance, is an instance of the PhotoShare application, however configured for use for with a computing device such as the display device 104. The application variant 124 shares core functionality with the client device application 122, such as to interact with and view various digital content displayed as part of a social media photo sharing experience, however, includes one or more different display, interface, and/or processing settings.

For instance, as part of the content connectivity session 202 the client device 102 causes the display device 104 to display an application interface 306 associated with the application variant 124. The application interface 306 includes similar selectable indicia 304 as the mobile application interface 302, however in the application interface 306 the several selectable indicia 304 are positioned on a left side of the display device 104 to facilitate an intuitive user experience. Further, because the display device 104 has a larger screen than the client device 102, the application interface 306 includes labels for the selectable indicia 304 (e.g., “home”, “bookmarks”, etc.) as well as an additional icon for “messages.”

The application interface 306 further leverages the expanded display screen to include a section 308 that includes suggested accounts of the social media application. Additionally, the application variant 124 includes processing settings particular to the display device 104 that facilitate efficient computational resource usage of the display device 104. For instance, the processing settings include power management settings, latency handling settings, audio processing settings, etc. The application interface 306 is further configured to support cursor-based input mechanisms 120, whereas the mobile application interface 302 is configured for touch inputs, e.g., via a touchscreen.

The client device 102 further determines an operational state of the client device application 122 and configures the application variant 124 to match the operational state of the client device application 122. For instance, the client device 102 configures the application variant 124 to implement a same account of the client device application 122 and to internally navigate within the application interface 306 to display a same photo as the mobile application interface 302. In this way, the techniques described herein provide a seamless transition from interaction with the mobile application interface 302 by the client device 102 to interaction with the application interface 306 in a content connectivity session 202, e.g., in a content casting scenario. The techniques described herein further conserve computational resources relative to conventional approaches while enhancing a user experience.

In this example, the client device 102 continues to execute the client device application 122 in a foreground, while executing the application variant 124 in the background such that application content 204 associated with the application variant 124 is communicated to the display device 104 for display as part of the content connectivity session 202. In this way, the client device 102 displays the mobile application interface 302 during the content connectivity session 202 while the display device 104 displays the application interface 306 during the content connectivity session 202. This is by way of example and not limitation, and a variety of interface surfacing configurations are contemplated as discussed in the following examples.

FIGS. 4a, 4b, 4c, and 4d depict example implementations 400a, 400b, 400c, 400d for managing application variants in a content connectivity session in which video streaming application variants are managed in accordance with one or more implementations. As shown in FIG. 4a, a client device 102 establishes a content connectivity session 202 with a display device 104. The client device 102 further receives an input to launch a client device application 122 which in this example is a video streaming application usable to view a digital video.

The client device application 122 displays a mobile application interface 402 that has processing, display, and interface settings configured (e.g., optimized) for use by the client device 102, which in the illustrated example is a mobile device. For instance, the mobile application interface 402 displays an episode of a television show at a particular time stamp. The mobile application interface 402 further includes relatively large touch-responsive icons that are easily actuatable by a user 108 in a mobile device context. For instance, the mobile application interface 402 includes a pause icon, an icon to rewind by a set amount of time (e.g., fifteen seconds) and an icon to fast forward by the set amount of time.

In accordance with the techniques described herein, the client device 102 launches an application variant 124. The application variant 124 represents the video streaming application, however, is configured with display, processing, and interface settings to optimize performance when used by the display device 104. As part of the content connectivity session 202, the client device 102 causes the display device 104 to display an application interface 404 associated with the application variant 124. The application interface 404 includes expanded icons relative to the mobile application interface 402, such as additional icons to change a display size of the video content and an icon to share the video content. Because the display device 104 has a larger screen than the client device 102, the application interface 404 further includes a title of the show which is not included in the mobile application interface 402.

Further, the client device 102 determines an operational state of the client device application 122 and configures the application variant 124 to match the operational state of the client device application 122. For instance, the client device 102 configures the application interface 404 to display a particular season, episode, and time stamp of the digital video at the particular time stamp. In this way, the techniques described herein can provide a seamless transition between viewing digital content from a mobile device, e.g., the client device 102, to viewing digital content in a screen casting scenario.

In this example, the client device 102 continues to execute the client device application 122 and continues to display the mobile application interface 402 during the content connectivity session 202. For instance, the client device 102 executes the client device application 122 in a foreground, while executing the application variant 124 in the background such that application content 204 associated with the application variant 124 is communicated to the display device 104 for display as part of the content connectivity session 202. Accordingly, the client device 102 displays the mobile application interface 402 while the display device 104 displays the application interface 404, such as to maintain optimal visual performance on both the client device 102 and the display device 104 during the content connectivity session 202.

As shown in FIG. 4b, in various examples the client device 102 terminates execution of the client device application 122, such as responsive to initiation of the content connectivity session 202 and/or launch of the application variant 124, and instead displays the application interface 404 of the application variant 124. In this example, the client device 102 terminates the client device application 122 upon launch of the application variant 124. Accordingly, the client device 102 and the display device 104 both display the application interface 404. In this example, the techniques described herein conserve computational resources by running a single application at a time.

As shown in FIG. 4c, in some examples the client device 102 terminates execution of the client device application 122 and further generates a controller interface 406. The controller interface 406, for instance, is operable to control application content 204 to be displayed by the display device 104 as part of the content connectivity session 202. For instance, the controller interface 406 includes various control buttons 408 to control the digital video depicted in the application interface 404. The controller interface 406 further includes a seekbar 410 to control a temporal property of the digital video displayed in the application interface 404. The controller interface 406 also includes a touchpad region 412. The touchpad region 412 for instance, can be used to control a virtual cursor to navigate features of the application interface 404. Thus, the techniques described herein support a variety of display options to support customizable content connectivity sessions 202.

As shown in FIG. 4d, in some examples the client device 102 terminates execution of the client device application 122 and further terminates display by the display screen 112. For instance, the client device 102 continues to execute the application variant 124 and causes the display device 104 to display the application interface 404, however ceases display of the mobile application interface 402 and the application interface 404 by the display screen 112. In this way, the techniques described herein are further able to conserve computational resources during the content connectivity session 202.

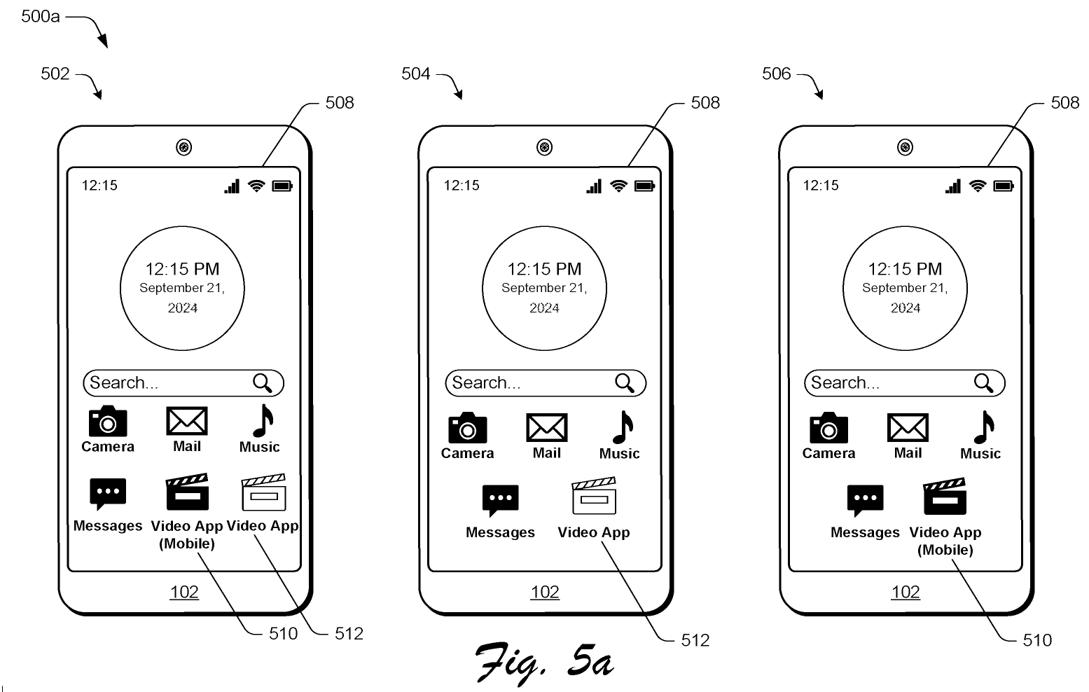

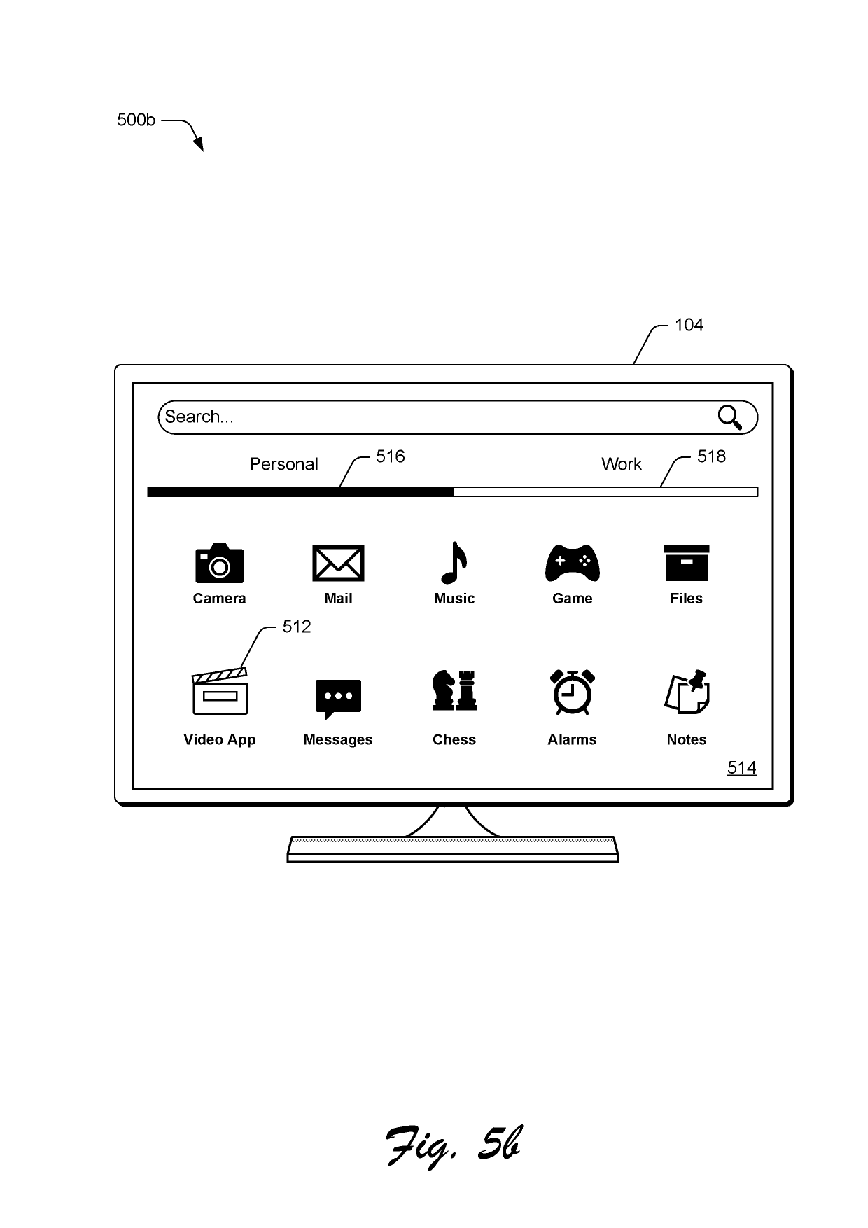

FIGS. 5a and 5b depict example implementations 500a, 500b for managing application variants in a content connectivity session in which various icon surfacing options are shown in accordance with one or more implementations. FIG. 5a, for instance, depicts example icon surfacing options in a first example 502, a second example 504, and a third example 506. In the first example 502, the client device 102 displays a mobile device interface 508 that includes a variety of selectable indicia such as icons that correspond to various applications 114. For instance, the mobile device interface 508 includes an icon that corresponds to a mobile video application 510 configured to display a variety of digital videos and is configured for use by the client device 102.

In this example, the mobile video application 510 is representative of the client device application 122. The mobile device interface 508 further includes an icon that corresponds to an alternative video application 512. The alternative video application 512, for instance, is representative of the application variant 124. Accordingly, the alternative video application 512 is configured to perform similar functionality as the mobile video application 510, however, is configured (e.g., optimized) for use by the display device 104. In the first example 502, the client device 102 surfaces both the mobile video application 510 and the alternative video application 512 in the mobile device interface 508. The client device 102 may surface and/or hide the mobile video application 510 and/or the alternative video application 512 in a variety of scenarios based on a variety of criteria.

In the second example 504, the client device 102 hides the icon associated with the mobile video application 510 from the mobile device interface 508. In various examples, the client device 102 leverages an interface management module 224 to remove one or more icons from display responsive to initiation of the content connectivity session 202 and/or responsive to a detected proximity to a display device 104. For instance, the interface management module 224 detects that the client device 102 is in proximity to the display device 104, e.g., the client device 102 is within a threshold distance of the display device 104. Responsive to the proximity detection, the interface management module 224 removes the mobile video application 510 icon from the mobile device interface 508.

In the third example 506, the client device 102 hides the icon associated with the alternative video application 512 from the mobile device interface 508 and instead surfaces the icons associated with the mobile video application 510. For instance, the client device determines that the content connectivity session 202 has terminated and/or the client device 102 is not in proximity to the display device 104. In this way, the techniques described herein streamline a user experience, such as to display icons for the mobile video application 510 and the alternative video application 512 when the applications are relatively likely to be used and hide icons for the mobile video application 510 and the alternative video application 512 when they are relatively unlikely to be used.

FIG. 5b further depicts an example of icon surfacing options with respect to the display device 104. In this example, the client device 102 and the display device 104 are engaged in a content connectivity session 202. As part of the content connectivity session 202, the client device 102 causes the display device 104 to display an application tray 514 that includes icons associated with a variety of applications 114. Further, the display device 104 displays a personal tab 516 and a work tab 518. Selection of the personal tab 516 causes the display device 104 to display applications 114 associated with a personal user profile 222 while selection of the work tab 518 causes display of application 114 associated with a work user profile 222.

As part of the content connectivity session 202, the client device 102 is operable to hide the icon associated with the mobile video application 510 from display by the display device 104. Instead, the client device 102 causes the display device 104 to surface the icon associated with the alternative video application 512. In this way, the techniques described herein support an efficient user experience by managing duplicative icons associated with instances of applications.

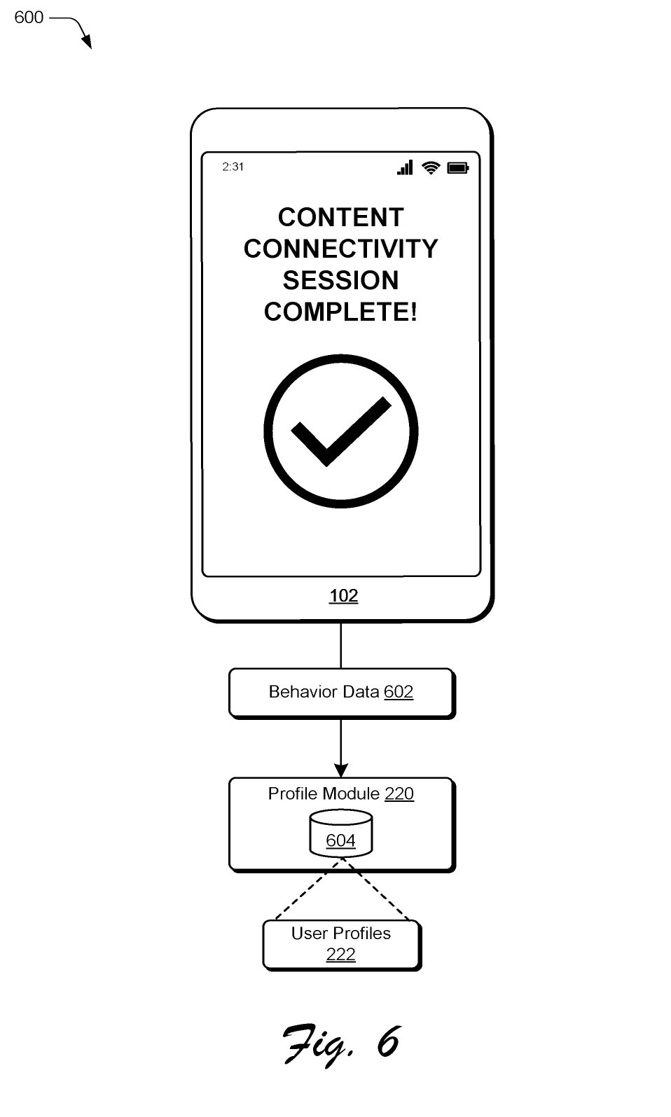

FIG. 6 depicts an example implementation 600 for managing application variants in a content connectivity session in which behavior data is stored in one or more user profiles in accordance with one or more implementations. The client device 102 can leverage a profile module 220 to collect a variety of behavior data 602, such as before, during, and/or after a content connectivity session 202. In the illustrated example, upon termination of the content connectivity session 202 the profile module 220 saves and/or processes the behavior data 602, such as to incorporate the behavior data 602 into one or more user profiles 222 located in storage 604.

The behavior data 602, for instance, describes various properties of the content connectivity session 202, such as how a user 108 interacts with one or more of the client device 102, the display device 104, the client device application 122, and/or the application variant 124. For instance, the behavior data 602 includes a start and stop timestamp of a content connectivity session 202, a frequency of use, a session duration, type of content being displayed, types of processing devices involved in the content connectivity session 202, applications 114 that are used for the content connectivity session 202, user activity during the content connectivity session 202, user customizations, user reactions and engagements, etc. In at least one example, the behavior data 602 includes sensor data from one or more sensors of the client device 102, such as to detect a user state (e.g., what a user 108 is “doing”) throughout the content connectivity session 202.

The profile module 220 can leverage the behavior data 602 for a variety of functionality. For instance, the profile module 220 can generate one or more user profiles 222 based on the behavior data 602. In one or more examples, the profile module 220 leverages a particular user profile 222 to predict screen sharing behavior of a user 108.

By way of example, the particular user profile 222 indicates that a client device 102 associated with a user 108 frequently implements a content connectivity session 202 with productivity applications at a particular time of day, e.g., during work hours. The client device 102 downloads a mobile application configured for a productivity task. In this example, the profile module 220 calculates a likelihood based on the behavior data 602 that the user 108 will initiate a content connectivity session 202 with the mobile application. Based on the likelihood being above a threshold, the profile module 220 causes the client device 102 to download an application variant 124 of the mobile application, and/or generate a suggestion to download the application variant 124. In this way, the techniques described herein are usable to predict user behavior to enhance a user experience with content connectivity sessions 202.

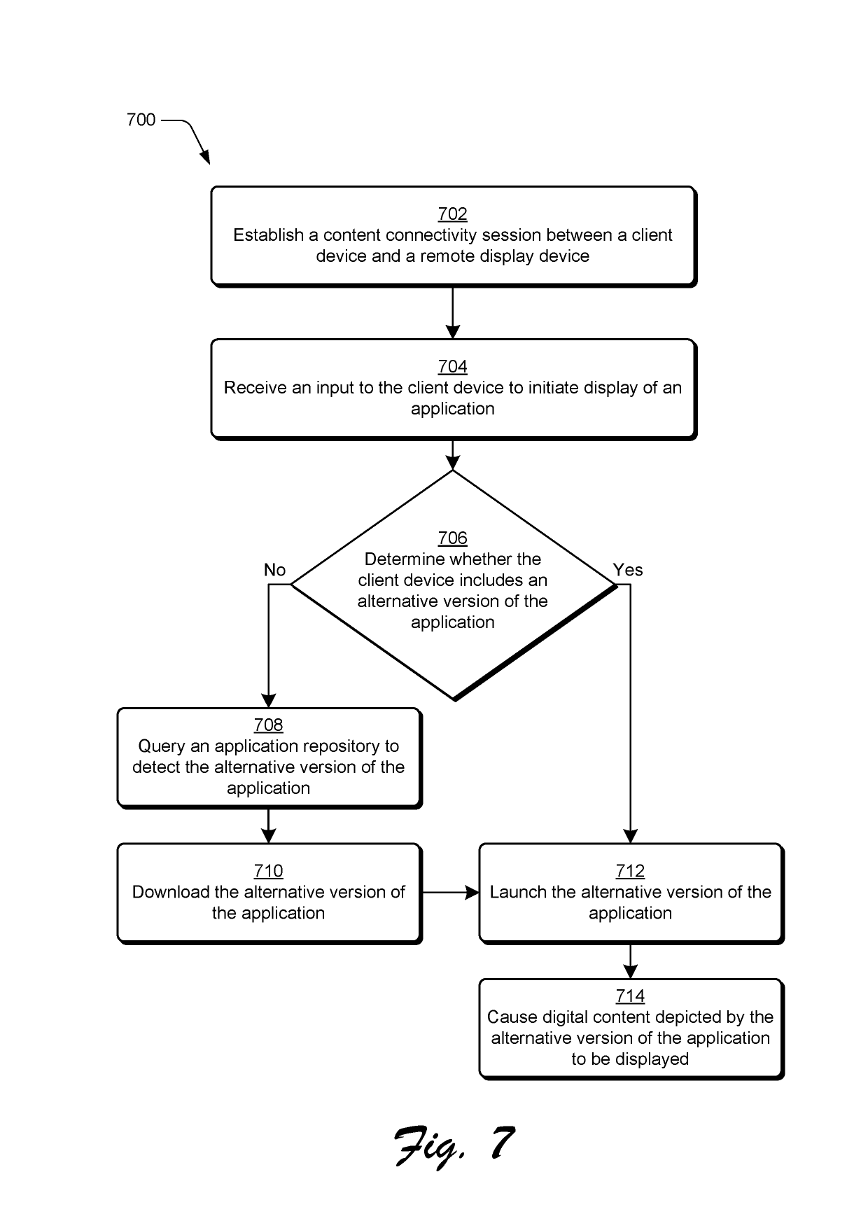

FIG. 7 illustrates a flow chart depicting an example method 700 for managing application variants in a content connectivity session in accordance with one or more implementations. Operations of the method 700, for instance, may be performed in the context of the environment 100, such as by the client device 102 and/or the display device 104.

At 702, a content connectivity session is established between a client device and a remote display device. The content connectivity session 202, for instance, enables the client device 102 to transmit content to the display device 104 for output via wireless and/or wired connectivity. As part of the content connectivity session 202, the client device 102 causes application content 204 from one or more applications 114, e.g., a client device application 122 and/or an application variant 124, to be displayed by the display device 104.

At 704, an input is received to initiate display of an application. In an example, the application is a client device application 122 that is configured for use by the client device 102. For instance, the client device application 122 is adapted for use with display, processing, and/or interface settings of the client device 102, such as to optimize a performance of the client device 102 when executing the client device application 122.

At 706, it is determined whether the client device includes an alternative version of the application. The alternative version of the application, for instance, is an application variant 124 of the client device application 122. The application variant 124 can perform substantially similar functionality as the client device application 122, however is configured (e.g., optimized) for execution by a device different than the client device 102. For instance, the application variant 124 is adapted for use with display, interface, and/or processing settings of the display device 104. For example, the application variant 124 includes application configuration parameters that are set to operate within predefined thresholds that maximize a performance, stability, and/or user experience of the application variant 124 when executed by the display device 104.

If the client device does not include the alternative version of the application (“No”), at 708 an application repository is queried to detect the alternative version of the application. The application repository 210, for instance, maintains application data 212 that pertains to a variety of applications 114 in storage 214. In one or more examples, the application repository 210 is representative of an application “store” such as a digital platform to browse, download, update, and/or install a variety of applications 114. The client device 102, for instance, detects the application variant 124 by comparing metadata of candidate applications with the client device application 122 and/or settings of the display device 104.

In at least one example, the client device 102 determines that neither the client device 102 nor the application repository 210 include a suitable application variant 124. Accordingly, the client device 102 is configured to edit application content 204 of the client device application 122 to improve display of the application content 204 by the display device 104, e.g., by adjusting one or more display, processing, and/or interface settings included in the application content 204.

At 710, the alternative version of the application is downloaded. For instance, the client device 102 interacts with the application repository 210 to download the application variant 124. In various examples, the client device 102 can then determine that the client device 102 includes the application variant 124.

For instance, if the client device includes the alternative version of the application (“Yes”), at 712 the alternative version of the application is launched. For instance, the client device 102 leverages one or more processing resources to execute the application variant 124. In various examples, the client device 102 executes the app in one or more of a foreground process and/or a background process.

At 714, digital content depicted by the alternative version of the application is displayed. For instance, the client device 102 causes the display device 104 to display application content 204 from the application variant 124. As described above, the application variant 124 is configured with display, processing, and/or interface settings particular to the display device 104. Accordingly, by launching the application variant 124 automatically, the techniques described herein support an enhanced user experience within a content connectivity session 202.

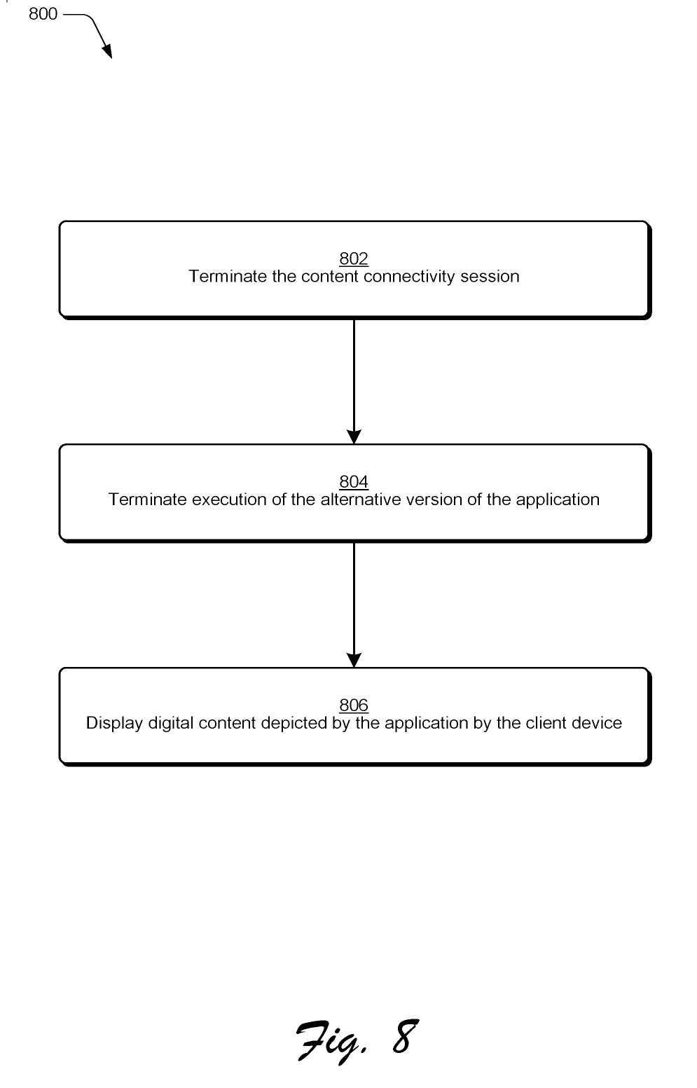

FIG. 8 illustrates a flow chart depicting an example method 800 for managing application variants in a content connectivity session in accordance with one or more implementations. Operations of the method 800, for instance, may be performed in the context of the environment 100, such as by the client device 102 and/or the display device 104. In various examples, one or more steps of the example method 800 are implemented as one or more substeps of the example method 700.

At 802, the content connectivity session is terminated. For instance, the client device 102 ceases communication of application content 204 for display by the display device 104. In various examples, the content connectivity session 202 is terminated via input, e.g., user input to the one or more input mechanisms 120. Additionally or alternatively, the content connectivity session 202 is terminated automatically and without user intervention.

At 804, execution of the alternative version of the application is terminated. For instance, responsive to termination of the content connectivity session 202 the client device 102 closes the application variant 124.

At 806, digital content depicted by the application is displayed by the client device. For instance, the client device 102 resumes display of the digital content depicted by the client device application 122 upon termination of the application variant 124. In an example in which the client device application 122 has been running in the background, the client device 102 can transition the client device application 122 to foreground execution. In an example in which the client device application 122 is closed for a duration of the content connectivity session 202, the client device 102 can relaunch the client device application 122 and further match an application state 218 of the client device application 122 to an application state of the application variant 124.

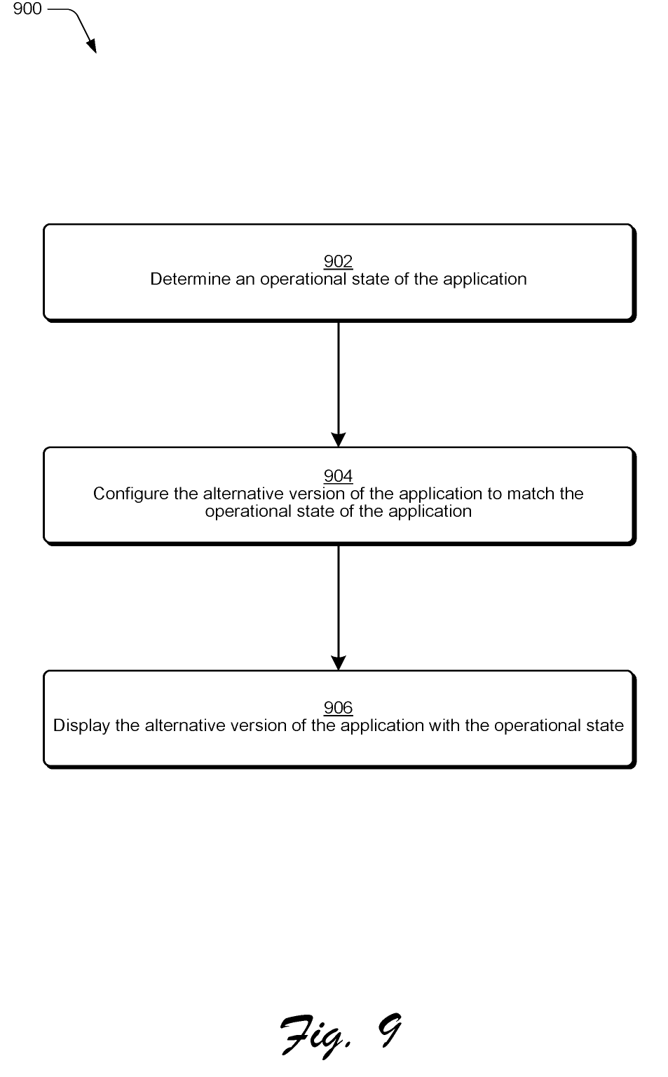

FIG. 9 illustrates a flow chart depicting an example method 900 for managing application variants in a content connectivity session in accordance with one or more implementations. Operations of the method 900, for instance, may be performed in the context of the environment 100, such as by the client device 102 and/or the display device 104. In various examples, one or more steps of the example method 900 are implemented as one or more substeps of the example method 700 and/or the example method 800.

At 902, an operational state of the application is determined. The operational state, for instance, is an application state 218 that includes a current condition and/or status of an application 114 at a particular moment in time. The application state 218 may include one or more data elements, variables, and/or an operational context of an application 114 at a particular moment such as behavior, processing activities, and/or user interactions related to the application 114. In an example in which the client device application 122 is a video streaming application, the operational state includes display of a particular video at a particular time stamp.

At 904, the alternative version of the application is configured to match the operational state of the application. For instance, the client device 102 configures the application variant 124 to emulate the operational state of the client device application 122. Continuing with the above example in which the client device application 122 and the application variant 124 are video streaming applications, the client device 102 configures the application variant 124 to navigate the particular video to the particular time stamp.

At 906, the alternative version of the application is displayed with the operational state. For instance, the client device 102 causes the display device 104 to display the application variant 124 as having the application state 218 of the client device application 122. In this way, the techniques described herein provide a seamless transition between application content 204 displayed by the client device application 122, e.g., displayed via the client device 102, and application content 204 displayed by the application variant 124, e.g., displayed via the display device 104.

FIG. 10 illustrates various components of an example device 1000 in which aspects of managing application variants in a content connectivity session can be implemented. The example device 1000 can be implemented as any of the devices described with reference to the previous FIGS. 1-9, such as any type of mobile device, mobile phone, mobile device, wearable device, tablet, computing, communication, entertainment, gaming, media playback, and/or other type of electronic device. For example, the client device 102 as shown and described with reference to FIGS. 1-9 may be implemented as the example device 1000.

The device 1000 includes communication transceivers 1002 that enable wired and/or wireless communication of device data 1004 with other devices. The device data 1004 can include any of device identifying data, device location data, wireless connectivity data, and wireless protocol data. Additionally, the device data 1004 can include any type of audio, video, and/or image data. Example communication transceivers 1002 include wireless personal area network (WPAN) radios compliant with various IEEE 1002.15 (BluetoothTM) standards, wireless local area network (WLAN) radios compliant with any of the various IEEE 1002.11 (Wi-FiTM) standards, wireless wide area network (WWAN) radios for cellular phone communication, wireless metropolitan area network (WMAN) radios compliant with various IEEE 1002.16 (WiMAXTM) standards, and wired local area network (LAN) Ethernet transceivers for network data communication.

The device 1000 may also include one or more data input ports 1006 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1000 includes a processing system 1008 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1010. The device 1000 may further include any type of a system bus or other data and command transfer system that couples the various components within the device. A system bus can include any one or combination of different bus structures and architectures, as well as control and data lines.

The device 1000 also includes computer-readable storage memory 1012 (e.g., memory devices) that enable data storage, such as data storage devices that can be accessed by a computing device, and that provide persistent storage of data and executable instructions (e.g., software applications, programs, functions, and the like). Examples of the computer-readable storage memory 1012 include volatile memory and non-volatile memory, fixed and removable media devices, and any suitable memory device or electronic data storage that maintains data for computing device access. The computer-readable storage memory can include various implementations of random-access memory (RAM), read-only memory (ROM), flash memory, and other types of storage media in various memory device configurations. The device 1000 may also include a mass storage media device.

The computer-readable storage memory 1012 provides data storage mechanisms to store the device data 1004, other types of information and/or data, and various device applications 1014 (e.g., software applications). For example, an operating system 1016 can be maintained as software instructions with a memory device and executed by the processing system 1008. The device applications may also include a device manager, such as any form of a control application, software application, signal-processing and control module, code that is native to a particular device, a hardware abstraction layer for a particular device, and so on. Computer-readable storage memory 1012 represents media and/or devices that enable persistent and/or non-transitory storage of information in contrast to mere signal transmission, carrier waves, or signals per se. Computer-readable storage memory 1012 do not include signals per se or transitory signals.

In this example, the device 1000 includes a content control module 1018 that implements aspects of managing application variants in a content connectivity session and may be implemented with hardware components and/or in software as one of the device applications 1014. In an example, the content control module 1018 can be implemented as the content control module 116 described in detail above. In implementations, the content control module 1018 may include independent processing, memory, and logic components as a computing and/or electronic device integrated with the device 1000. The device 1000 also includes digital content data 1020 for implementing aspects of managing application variants in a content connectivity session and may include data from and/or utilized by the content control module 1018.

In this example, the example device 1000 also includes a camera 1022 and motion sensors 1024, such as may be implemented in an inertial measurement unit (IMU). The motion sensors 1024 can be implemented with various sensors, such as a gyroscope, an accelerometer, and/or other types of motion sensors to sense motion of the device. The various motion sensors 1024 may also be implemented as components of an inertial measurement unit in the device.

The device 1000 also includes a wireless module 1026, which is representative of functionality to perform various wireless communication tasks. For instance, for the client device 102, the wireless module 1026 can be leveraged to scan for and detect wireless networks, as well as negotiate wireless connectivity to wireless networks for the client device 102. The device 1000 can also include one or more power sources 1028, such as when the device is implemented as a mobile device. The power sources 1028 may include a charging and/or power system, and can be implemented as a flexible strip battery, a rechargeable battery, a charged super-capacitor, and/or any other type of active or passive power source.

The device 1000 also includes an audio and/or video processing system 1030 that generates audio data for an audio system 1032 and/or generates display data for a display system 1034. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1036. In implementations, the audio system and/or the display system are integrated components of the example device. Alternatively, the audio system and/or the display system are external, peripheral components to the example device.

Although implementations of managing application variants in a content connectivity session have been described in language specific to features and/or methods, the subject of the appended claims is not necessarily limited to the specific features or methods described. Rather, the features and methods are disclosed as example implementations of managing application variants in a content connectivity session, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a client device including: at least one memory; and at least one processor coupled with the at least one memory and configured to cause the client device to: establish a content connectivity session between the client device and a remote display device; receive an input to initiate display of an application depicting digital content, the application configured with one or more settings particular to the client device; launch, during the content connectivity session, an alternative version of the application configured with one or more settings particular to the remote display device; and cause digital content depicted by the alternative version of the application to be displayed by the remote display device.

In some aspects, the techniques described herein relate to a client device, wherein the application is adapted for use with one or more display, processing, or interface settings of the client device and the alternative version of the application is adapted for use with one or more display, processing, or interface settings of the remote display device.

In some aspects, the techniques described herein relate to a client device, wherein the at least one processor is configured to cause the client device to: determine that the client device does not include the alternative version of the application; query an application repository to detect whether the application repository includes the alternative version of the application; and download the alternative version of the application from the application repository.

In some aspects, the techniques described herein relate to a client device, wherein the at least one processor is configured to cause the client device to determine an operational state of the application and configure the alternative version of the application to match the operational state of the application.

In some aspects, the techniques described herein relate to a client device, wherein the application is a video streaming application and the operational state includes display of a digital video at a particular time stamp by the video streaming application.

In some aspects, the techniques described herein relate to a client device, wherein the at least one processor is configured to cause the client device to terminate execution of the application responsive to the launch of the alternative version of the application.

In some aspects, the techniques described herein relate to a client device, wherein the at least one processor is configured to cause the client device to detect a user profile associated with the application and associate the user profile with the alternative version of the application.

In some aspects, the techniques described herein relate to a client device, wherein the at least one processor is configured to cause the client device to: terminate the content connectivity session and execution of the alternative version of the application; and display the digital content depicted by the application in a user interface of the client device.

In some aspects, the techniques described herein relate to a client device, wherein the at least one processor is configured to cause the client device to hide an icon associated with the application from a user interface of the client device for a duration of the content connectivity session.

In some aspects, the techniques described herein relate to a method performed by a client device, the method including: establishing a content connectivity session between the client device and a remote display device; receiving an input to initiate display of an application that depicts digital content, the application configured for the client device; querying an application repository to detect an alternative version of the application, the alternative version configured to depict the digital content by the remote display device; downloading the alternative version of the application; and launching the alternative version of the application causing the digital content depicted by the alternative version to be displayed by the remote display device as part of the content connectivity session.

In some aspects, the techniques described herein relate to a method, wherein the application is optimized for display settings of the client device and the alternative version of the application is optimized for display settings of the remote display device.

In some aspects, the techniques described herein relate to a method, wherein the application is optimized for processing settings of the client device and the alternative version of the application is optimized for processing settings of the remote display device.

In some aspects, the techniques described herein relate to a method, wherein the querying the application repository is performed responsive to a determination that the client device does not include the alternative version of the application.

In some aspects, the techniques described herein relate to a method, further including: determining an operational state of the application; and configuring the alternative version of the application to match the operational state of the application.

In some aspects, the techniques described herein relate to a method, further including terminating execution of the application on the client device responsive to the launching the alternative version of the application.

In some aspects, the techniques described herein relate to a method, further including displaying the digital content depicted by the application in a user interface of the client device while causing the digital content depicted by the alternative version of the application to be displayed by the remote display device during the content connectivity session.

In some aspects, the techniques described herein relate to a system including: a remote display device to display digital content received during a content connectivity session; and a client device configured to: receive an input to initiate display of an application depicting digital content, the application configured for the client device; determine whether the client device includes an alternative version of the application configured for the remote display device; and launch the alternative version of the application causing the digital content depicted by the alternative version of the application to be displayed by the remote display device.

In some aspects, the techniques described herein relate to a system, wherein the application is a mobile device application adapted for use with display and processing capabilities of the client device, and the alternative version of the application is adapted for use with display and processing capabilities of the remote display device.

In some aspects, the techniques described herein relate to a system, wherein the client device is configured to: query an application repository for the alternative version of the application; and download the alternative version of the application from the application repository.

In some aspects, the techniques described herein relate to a system, wherein the digital content depicted by the application is displayed in a user interface of the client device while the digital content depicted by the alternative version of the application is displayed by the remote display device during the content connectivity session.

1. A client device comprising:
at least one memory; and
at least one processor coupled with the at least one memory and configured to cause the client device to:
establish a content connectivity session between the client device and a remote display device;
receive an input to initiate display of an application depicting digital content, the application configured with one or more settings particular to the client device;
launch, during the content connectivity session, an alternative version of the application configured with one or more settings particular to the remote display device; and
cause digital content depicted by the alternative version of the application to be displayed by the remote display device.

2. The client device of claim 1, wherein the application is adapted for use with one or more display, processing, or interface settings of the client device and the alternative version of the application is adapted for use with one or more display, processing, or interface settings of the remote display device.

3. The client device of claim 1, wherein the at least one processor is configured to cause the client device to:
determine that the client device does not include the alternative version of the application;
query an application repository to detect whether the application repository includes the alternative version of the application; and
download the alternative version of the application from the application repository.

4. The client device of claim 1, wherein the at least one processor is configured to cause the client device to determine an operational state of the application and configure the alternative version of the application to match the operational state of the application.

5. The client device of claim 4, wherein the application is a video streaming application and the operational state includes display of a digital video at a particular time stamp by the video streaming application.

6. The client device of claim 1, wherein the at least one processor is configured to cause the client device to terminate execution of the application responsive to the launch of the alternative version of the application.

7. The client device of claim 1, wherein the at least one processor is configured to cause the client device to detect a user profile associated with the application and associate the user profile with the alternative version of the application.

8. The client device of claim 1, wherein the at least one processor is configured to cause the client device to:
terminate the content connectivity session and execution of the alternative version of the application; and
display the digital content depicted by the application in a user interface of the client device.

9. The client device of claim 1, wherein the at least one processor is configured to cause the client device to hide an icon associated with the application from a user interface of the client device for a duration of the content connectivity session.

10. A method performed by a client device, the method comprising:
establishing a content connectivity session between the client device and a remote display device;
receiving an input to initiate display of an application that depicts digital content, the application configured for the client device;
querying an application repository to detect an alternative version of the application, the alternative version configured to depict the digital content by the remote display device;
downloading the alternative version of the application; and
launching the alternative version of the application causing the digital content depicted by the alternative version to be displayed by the remote display device as part of the content connectivity session.

11. The method of claim 10, wherein the application is optimized for display settings of the client device and the alternative version of the application is optimized for display settings of the remote display device.

12. The method of claim 10, wherein the application is optimized for processing settings of the client device and the alternative version of the application is optimized for processing settings of the remote display device.

13. The method of claim 10, wherein the querying the application repository is performed responsive to a determination that the client device does not include the alternative version of the application.

14. The method of claim 10, further comprising:
determining an operational state of the application; and
configuring the alternative version of the application to match the operational state of the application.

15. The method of claim 10, further comprising terminating execution of the application on the client device responsive to the launching the alternative version of the application.

16. The method of claim 10, further comprising displaying the digital content depicted by the application in a user interface of the client device while causing the digital content depicted by the alternative version of the application to be displayed by the remote display device during the content connectivity session.

17. A system comprising:
a remote display device to display digital content received during a content connectivity session; and
a client device configured to:
receive an input to initiate display of an application depicting digital content, the application configured for the client device;
determine whether the client device includes an alternative version of the application configured for the remote display device; and
launch the alternative version of the application causing the digital content depicted by the alternative version of the application to be displayed by the remote display device.

18. The system of claim 17, wherein the application is a mobile device application adapted for use with display and processing capabilities of the client device, and the alternative version of the application is adapted for use with display and processing capabilities of the remote display device.

19. The system of claim 17, wherein the client device is configured to:
query an application repository for the alternative version of the application; and
download the alternative version of the application from the application repository.

20. The system of claim 17, wherein the digital content depicted by the application is displayed in a user interface of the client device while the digital content depicted by the alternative version of the application is displayed by the remote display device during the content connectivity session.
